(19) United States
(12) Patent Application Publication
(10) Pub. No.: US 2021/0039853 A1
(43) Pub. Date: Feb. 11, 2021

(54) Recyclable Plastic Package

(71) Applicant: Colgate-Palmolive Company, New York, NY (US)

(72) Inventor: Jun WANG, Fort Washington, PA (US)

(73) Assignee: Colgate-Palmolive Company, New York, NY (US)

(21) Appl. No.: 16/976,112

(22) PCT Filed: Mar. 9, 2018
(86) PCT No.: PCT/US2018/021751

§ 371 Date: Aug. 27, 2020

(51) Int. Cl. B65D 65/40; B32B 27/32; B32B 7/12; B32B 15/085; B32B 27/08; B32B 15/20; B32B 7/02

(52) U.S. Cl. CPC B65D 65/40; B32B 27/32; B32B 7/12; B32B 15/085; B32B 27/08; B32B 2439/00; B32B 7/02; B32B 2307/72; B32B 2250/05; B32B 2250/24; B32B 15/20

(57) ABSTRACT

A recyclable package includes an outer layer consisting essentially of a first high-density polyethylene (HDPE), an inner layer including a second HDPE, a barrier layer positioned between the outer layer and the inner layer, a first bonding layer positioned between the outer layer and the barrier layer, and a second bonding layer positioned between the inner layer and the barrier layer.

### BACKGROUND

Recycling is a way to prevent waste material from being deposited in a landfill. Currently, rigid packaging, such as polyethylene terephthalate (PET) bottles and high-density polyethylene (HDPE) bottles, may be recycled. However, flexible packaging, such as (e.g., toothpaste) tubes, may not be recycled for two reasons. First, the tubes are made from multiple different plastics, such as low-density polyethylene (LDPE), linear low-density polyethylene (LLDPE), HDPE, polypropylene (PP), ethylene vinyl alcohol (EVOH), aluminum foil, and mixtures of these materials are not recyclable. Second, the infrastructure of recycling plants is not designed to receive and process flexible packaging.

### BRIEF SUMMARY

A recyclable package is disclosed. The package includes an outer layer consisting essentially of a first high-density polyethylene (HDPE), an inner layer including a second HDPE, a barrier layer positioned between the outer layer and the inner layer, a first bonding layer positioned between the outer layer and the barrier layer, and a second bonding layer positioned between the inner layer and the barrier layer.

In another embodiment, the recyclable package consists of an outer layer consisting essentially of a first high-density polyethylene (HDPE), an inner layer consisting essentially of a second HDPE, a barrier layer positioned between the outer layer and the inner layer, a first bonding layer positioned between the outer layer and the barrier layer, and a second bonding layer positioned between the inner layer and the barrier layer.

In yet another embodiment, the recyclable package includes an outer layer including a high-density polyethylene (HDPE), an inner layer including the HDPE, a barrier layer positioned between the outer layer and the inner layer; a first bonding layer positioned between the outer layer and the barrier layer; and a second bonding layer positioned between the inner layer and the barrier layer. The outer layer and the inner layer do not include a low-density polyethylene (LDPE), a linear low-density polyethylene (LLDPE), a medium-density polyethylene (MDPE), or a polypropylene (PP).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawing, wherein:

FIG. 1 depicts a side view of an example of a flexible package (e.g., a tube), according to an embodiment.

FIG. 2 depicts a cross-sectional side view of the side wall of an example of the flexible package shown in FIG. 1, according to an embodiment.

### DETAILED DESCRIPTION

The following description of the preferred embodiment(s) is merely exemplary in nature and is in no way intended to limit the invention, its applications, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

A flexible package (e.g., a tube) that is capable of being recycled is disclosed herein. The flexible package includes a sleeve portion and a shoulder portion that are made using HDPE grades that have similar mechanical and thermal properties to the HDPE grades used in recyclable bottles. In the sleeve portion, a low percentage of EVOH and tie resin may be used to provide a flavor/fragrance barrier. The materials used to make the flexible package are compatible with the existing HDPE bottle recycling stream because the low percentage of the contaminants (e.g., EVOH, tie resin, etc.) do not affect the processing and performance properties of recycled HDPE resin. Therefore, the contaminants may be recycled with the base resin (e.g., a pigmented HDPE bottle resin).

The sleeve portion and shoulder portion meet their respective specifications for the current conventional tube-making processes. More particularly, the sleeve portion is flat with sufficient printability and sealibility, and it's coefficient of friction (COF) falls within the range that conventional tube-making machines can handle. The specifications for the shoulder portion include the productivity and the dimension stability.

The conventional shoulder portion uses injection molding grade HDPE with a high melt flow index (e.g., 12-40 measured at 190 C/2.16 kg (ASTM D1238, ISO 1133), which may be considered a contaminate in the bottle-grade HDPE, which has melt flow index of 0.2-0.7. As a result, the recyclable flexible package disclosed herein uses a low melt flow index HDPE of 0.9-4.0, and the injection molding process temperature was increased to increase its melt flow to meet the injection molding production speed. Normally, a low melt index grade resin has slow melt flow and is difficult to process at high speed like in an injection molding process. Here, however, a balance was found between a low melt index close to bottle grade HDPE and a processability to meet injection molding productivity (production speed). The flexible package disclosed herein can be made using the conventional tube-making processes, and can be collected, separated, and recovered for reuse according to the conventional HDPE bottle recycling stream.

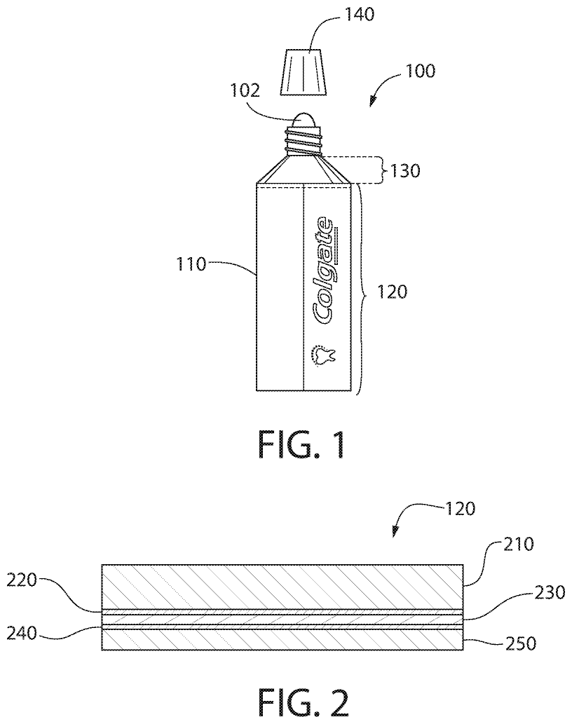

FIG. 1 depicts a side view of an example of a flexible package (e.g., a tube) 100, according to an embodiment. The flexible package 100 includes a body 110 that defines an internal volume in which a consumer product 102 may be stored. The consumer product 102 may be almost any viscous liquid, gel, or paste product, examples of which include toothpaste, mouthwash, condiments (e.g., ketchup, mustard, mayonnaise), soap, detergent, medicinal preparations, bodywash, body lotion, shampoo, cosmetic products (e.g., creams).

The body 110 may include a sleeve portion 120 and a shoulder portion 130. As described below, the shoulder portion 130 may be formed via injection molding (e.g., from HDPE). In at least one embodiment, an insert (not shown) may be positioned under or lining the inside of the shoulder portion 130, for example, to prevent the flavor/fragrance of the consumer product 102 from leaching into or leaking through the shoulder portion 130. The flexible package 100 may also include a cap 140 that is used to cover an opening through which the consumer product 102 may flow. The cap 140 may be made from polypropylene. The cap 140 does not affect the recyclability because 1) it can be removed and separated from the tube body and 2) in the recycling industry, there is a certain level of tolerance of polypropylene in HDPE; therefore, the recommendation from recycling industry is to leave the cap on for bottles, such as detergent bottles.

FIG. 2 depicts a cross-sectional side view of an example of a portion (e.g., a sleeve portion 120 of the side wall) of the flexible package 100 shown in FIG. 1, according to an embodiment. The sleeve portion 120 of the flexible package 100 may include a first, (e.g., outer) layer 210 and a second (e.g., inner) layer 250 that are made via a cast film or a blown film process. The sleeve portion 120 (including the outer and inner layers 210, 250) may be made via one step (e.g., via a co-extruded cast film-making process or a blown film-making process). In other words, the outer and inner layers 250 may be made simultaneously, not separately. The outer and/or inner layers 210, 250 may be single-layer or include multiple sub-layers.

The outer and inner layers 210, 250 may be made from HDPE. In some embodiments, the outer and inner layers 210, 250 may also include a pigment (e.g., a white pigment), as described below. However, the outer and inner layers 210, 250 may not include LDPE, LLDPE, medium density polyethylene (MDPE), and/or PP-based elastomers/plastomers, other than possibly trace amounts. Thus, the terms “consisting of a HDPE” and “consisting essentially of a HDPE” may mean including the HDPE and a possibly a pigment, but not including LDPE, LLDPE, MDPE, and/or PP, except for amounts that are less than the threshold for the HDPE recycling stream. These materials are absent from the outer layer 210 and the inner layer 250 in order to enable recycling using existing conventional HDPE bottle recycling stream. However, in one embodiment, as described below, some LDPE and/or LLDPE may be used in the inner layer 250 to provide sealability and to still keep the total density of the material within the bottle HDPE density recycling range.

In various examples, the HDPE may have a density that is greater than about 0.94 g/cm³ or about 0.96 g/cm³. For example, the HDPE may have a density that is from about 0.94 g/cm³ to about 1.00 g/cm³, about 0.96 g/cm³ to about 1.00 g/cm³. In some examples, the HDPE may have a melt flow index that is less than 1.0 g/10 min. In other examples, the melt flow index may be from about 0.3 g/10 min to about 5.0 g/10 min, about 0.8 g/10 min to about 1.4 g/10 min, or about 0.5 g/10 min to about 1.0 g/10 min or greater, measured at 190 C/2.16 kg (ASTM D1238, ISO 1133).

The outer layer 210 may be proportioned to provide mechanical strength and rigidity to the flexible package 100. In various examples, the outer layer 210 may have a thickness from about 100 μm to about 300 μm. For example, the outer layer 210 may have a thickness from about 180 μm to about 250 μm, about 150 μm to about 170 μm, about 160 μm to about 180 μm, about 120 μm to about 140 μm, about 145 μm to about 165 μm. The outer layer 210 may include a compatibilizer in an amount from about 5 wt % to about 20 wt %, and the compatibilizer may have a density from about 0.85 g/cm³ to about 0.90 g/cm³.

The inner layer 250 may be proportioned to provide a sealing function to the flexible package 100 and to provide a good sealing at the side seam and, in the shoulder portion 130, and at the end of the seal after the flexible package 100 is filled with the consumer product 102. In at least one embodiment, the inner layer 250 may have a thickness that is less than the thickness of the outer layer 210 to reduce its scalping of the flavor/fragrance of the consumer product 102. In various examples, the inner layer 250 may be less than 100 μm thick in order to reduce the loss of quality of the enclosed consumer product 102 due to either the consumer product's volatile flavors being absorbed by the inner layer 250 or the consumer product 102 absorbing undesirable flavors from the inner layer 250. For example, the inner layer 250 may have a thickness from about 20 μm to about 100 μm, about 30 μm to about 50 μm, about 40 μm to about 60 μm, about 30 μm to about 40 μm, about 40 μm to about 50 μm, or about 45 μm to about 55 μm.

The outer and inner layers 210, 250 may be bonded together with a barrier layer 230 positioned therebetween. More particularly as shown in the example of FIG. 2, a first (e.g., outer) bonding layer 220 may be positioned between the outer layer 210 and the barrier layer 230, and a second (e.g., inner) bonding layer 240 may be positioned between the inner layer 250 and the barrier layer 230. In various examples, the barrier layer 230 may have a thickness from about 3 μm to about 30 μm, and the first and/or second bonding layers 220, 240 may have a thickness from about 3 μm to about 10 μm or about 10 μm to about 30 μm.

The process (e.g., in addition to a one-step co-extrusion film-making process or blown film-making process) may be or include adhesive lamination and/or extrusion lamination. In the adhesive lamination process, the first and second bonding layers 220, 240 may be or include an adhesive material to bond/adhere the outer and inner layers 210, 250 to the barrier layer 230. In the extrusion lamination process, the first and second bonding layers 220, 240 may be or include an extruded melted tie resin (e.g., ethylene acrylic acid (EAA)) to bond/adhere the outer and inner layers 210, 250 to the barrier layer 230. The barrier layer 230 may be a plastic material (e.g., ethylene-vinyl alcohol copolymer (EVOH)), in which case the laminate is referred to as plastic barrier laminate (PBL).

The flexible package 100 may have a basic weight or density from about 270 g/sqm to about 310 g/sqm, about 225 g/sqm to about 265 g/sqm, about 205 g/sqm to about 245 g/sqm, about 220 g/sqm to about 260 g/sqm, or about 230 g/sqm to about 270 g/sqm. The flexible package 100 may have a static coefficient of friction from about 0.36 to about 0.46, from about 0.20 to about 0.30, about 0.30 to about 0.40, about 0.35 to about 0.40, or about 0.45 to about 0.50, as measured by ASTM D1894. The flexible package 100 may have a kinetic coefficient of friction from about 0.36 to about 0.46, from about 0.20 to about 0.30, about 0.30 to about 0.40, about 0.35 to about 0.40, or about 0.45 to about 0.50, as measured by ASTM D1894. The flexible package 100 may have a free-falling dart impact strength from about 430 g to about 460 g, from about 450 g to about 480 g, from about 390 g to about 420 g, about 385 g to about 415 g, or about 570 g to about 610 g, as measured by ASTM D1709.

In some examples, the sleeve portion 120 may further include a sealant layer (not shown in FIG. 2) that is inside the inner layer 250 (e.g., below inner layer 250 in the orientation of FIG. 2), and that further increases sealability. In some such examples, the sealant layer may be made of a thin layer of LLDPE, for example a layer of LLDPE having a thickness less than 30 μm, such as 15 μm.

### Example 1: Sleeve Portion 120

A 5-layer cast co-extrusion film sleeve portion 120 was made with the following structure (e.g., from outer to inner):
A first layer made of HDPE and having a thickness of 195 μm;
A second layer made of Tie resin and having a thickness of 5 μm;
A third layer made of EVOH and having a thickness of 15 μm;
A fourth layer made of Tie resin and having a thickness of 5 μm;
A fifth layer made of HDPE and having a thickness of 40 μm.

Thus, the thickness of the outer layer 210 was 195 μm, the thickness of the inner layer 250 was 40 μm, and the total thickness of the flexible package 100 was 260 μm. The HDPE in Example 1 had a density (d) of >0.95 g/cm³ and a melt flow index of <1 g/10 min. In a particular example, the HDPE may be or include Dow Chemical's Elite 5960G, which has a density of 0.964 and a melt flow of 0.85.

The tie resin was a functional co-polymer of polyethylene. In a particular example, the tie resin may be or include Dupont's BYNEL® series, Dow Chemical's PRIMACOR® series. The flexible package 100 in this example had a rigidity similar to a flexible package made of LDPE/LLDPE with a total thickness of 400 μm. Multiple other HDPEs can also be used, as shown in Tables 1 and 2 below, where MFR means melting flow rate (190° C./2.16 Kg), Tensile means tensile strength, E@B means elongation at break, Modulus means Young's or flexural modulus, Shore D means hardness, Tm means melting temperature, D means density in g/cm³, MI means melt flow index (190° C./2.16 Kg), Tensile @Y MD means tensile strength at yield in the machine direction, Tensile @ Y TD means tensile strength at yield in the transverse direction, E@B MD means elongation at break in the machine direction, and E@B TD means elongation at break in the transverse direction.

TABLE 1

| | | | | E@B | Modulus | | |
|---|---|---|---|---|---|---|---|
| Grade | Density | MFR | Tensile (Mpa) | (%) | (GPa) | Shore D | Tm (C) |
| Total BM 593 | 0.959 | 0.27 | 30 (12 u film) | 610 | 1.4 | | |
| Total 5908 | 0.961 | 0.80 | 32 (25 u) | 600 | 1.0 | | 135 |
| Total 9260 | 0.96 | 2 | 29 (50 u) | 800 | 1 | | 135 |
| Total D 4720 | 0.949 | 0.28 | 24 (25 u) | 600 | 0.8 | | 131 |
| Total 717 | 0.958 | 0.30 | 34 (12 u) | 300 | 1.3 | | 135 |
| DOW DGDC NT7 | 0.950 | 0.07 | 42 (13 u) | 350 | 1 | | 128 |
| Total mPE M 6040 | 0.960 | 4.0 | 23 (20 u) | 550 | | | 134 |
| Total mPE | 0.932 | 0.5 | 16 (40 u) | 600 | | | 123 |
| 32ST05 | | | | | | | |
| Total mPE M5510 | 0.955 | 1.2 | 28 | 900 | | | 134 |
| EP | | | | | | | |
| Total mPE M4707 | 0.947 | 0.7 | 25 | 600 | | | 131 |
| EP | | | | | | | |

TABLE 2

| | | | | | | | 1% Secant |
|---|---|---|---|---|---|---|---|
| | | | Tensile @Y | Tensile @Y | E@B | E@B | Modulus Kpsi |
| Grade | D | MI | MD (psi) | TD (psi) | MD | TD | MD/TD |
| Total 9260 | 0.96 | 2 | 4200 | 3600 | 850 | 500 | 140/180 |
| Total 6410 | 0.961 | 1.2 | 3800 | 4000 | 700 | 700 | 125/128 |
| Total 9548 | 0.958 | 0.45 | 4500 | 2600 | 270 | <10 | 152/199 |
| Total HL428 | .0947 | 0.28 | 3400 | 3800 | 450 | 600 | 103/145 |
| Total HL323 | 0.937 | 0.23 | 1800 | 2800 | 500 | 900 | 64/85 |
| Total | 0.934 | 0.9 | 6400(B) | 6100(B) | 400 | 650 | 53/56 |
| M3410EP | | | | | | | |
| Dow 5960G | 0.964 | 0.85 | 4100 | 4400 | 500 | 600 | 163/193 |

### Example 2: Sleeve Portion 120

A 7-layer cast co-extrusion film sleeve portion 120 was made with the following structure (e.g., from outer to inner):
A first layer made of HDPE and having a thickness of 45 μm;
A second layer made of HDPE with a white pigment and having a thickness of 45 μm
A third layer made of HDPE and having a thickness of 70 μm;
A fourth layer made of Tie resin and having a thickness of 15 μm;
A fifth layer made of EVOH and having a thickness of 15 μm;
A sixth layer made of Tie resin and having a thickness of 15 μm;
A seventh layer made of HDPE and having a thickness of 40 μm.

Thus, the outer layer 210 was made of three layers of HDPE and the thickness of the outer layer 210 was 160 μm, the thickness of the inner layer 250 was 40 μm, and the total thickness of the flexible package 100 was 245 μm. In this example, the HDPE was a metallene HDPE with a density of 0.960 g/cm and a melt flow index of 4.0 g/10 min. The produced film had a basic weight of 288.7 g/sqm, a coefficient of friction of 0.41/0.41 (static/kinetic), and a free-falling dart impact strength of 445 g.

### Example 3: Sleeve Portion 120

A 9-layer blown film sleeve portion 120 was made with the following structure (e.g., from outer to inner):
A first layer made of HDPE and having a thickness of 55 μm;
A second layer made of HDPE with a white pigment and having a thickness of 50 μm;
A third layer made of HDPE and having a thickness of 20 μm;
A fourth layer made of HDPE and having a thickness of 25 μm;
A fifth layer made of HDPE and having a thickness of 20 μm;
A sixth layer made of Tie resin and having a thickness of 15 μm;
A seventh layer made of EVOH and having a thickness of 15 μm;
An eighth layer made of Tie resin and having a thickness of 15 μm;
A ninth layer made of HDPE and having a thickness of 35 μm.

Thus, the outer layer 210 was made of five layers of HDPE, and the thickness of the outer layer 210 was 170 μm, the thickness of the inner layer 250 was 35 μm, and the total thickness of the flexible package 100 was 250 μm. The HDPE was a bimodal HDPE with a density of 0.951 g/cm³ and a melt flow index of 1.1 g/10 min. The produced film had a basic weight of 244.4 g/sqm, a coefficient of friction of 0.25/0.25 (static/kinetic), and a free-falling dart impact strength of 463 g. Due to the unsymmetrical layer structure, the film cured toward the outer side.

### Example 4: Sleeve Portion 120

A 9-layer blown film sleeve portion 120 with two HDPE grades was made. The two HDPE materials had different densities and were used to adjust the stress within different layers to obtain a flat film out of the unsymmetrical layer structure. The sleeve portion 120 had the following structure (e.g., from outer to inner):
A first layer made of HDPE1 and having a thickness of 30 μm;
A second layer made of HDPE2 and having a thickness of 50 μm;
A third layer made of HDPE2 with a white pigment and having a thickness of 25 μm;
A fourth layer made of HDPE2 with the white pigment and having a thickness of 25 μm;
A fifth layer made of Tie resin and having a thickness of 15 μm;
A sixth layer made of EVOH and having a thickness of 15 μm;
A seventh layer made of Tie resin and having a thickness of 15 μm;
An eighth layer made of HDPE1 and having a thickness of 20 μm;
A ninth layer made of HDPE1 and having a thickness of 25 μm.

Thus, the outer layer 210 was made of four layers of HDPE, and the thickness of the outer layer 210 was 130 μm, the thickness of the inner layer 250 was 45 μm, and the total thickness of the flexible package 100 was 220 μm. The HDPE was a bimodal HDPE material with a density of 0.951 g/cm³ and a melt flow index of 1.1 g/10 min. The HDPE2 was a high-stiffness grade material with a density of 0.965 g/cm³ and a melt flow index of 0.7 g/10 min. The produced film had a basic weight of 225.0 g/sqm, a coefficient of friction of 0.35/0.34 (static, kinetic), and a free-falling dart impact strength of 406 g. The film was flat with no curling in both the machine direction (MD) and the transverse direction (TD).

### Example 5: Sleeve Portion 120

This was an improved version of the sleeve portion 120 in Example 4 with improved sealibility to form a tube with strong mechanical properties. It was a 9-layer blown film sleeve portion 120 with two HDPE materials having different grades plus a thin layer of LLDPE as a sealant layer. The two HDPE materials had different densities and were used to adjust the stress within different layers to obtain a flat film out of the unsymmetrical layer structure. The sleeve portion 120 had the following structure (e.g., from outer to inner):
A first layer made of HDPE1 and having a thickness of 35 μm;
A second layer made of HDPE2 with a white pigment and having a thickness of 40 μm;
A third layer made of HDPE2 with a white pigment and having a thickness of 40 μm;
A fourth layer made of HDPE2 and having a thickness of 40 μm;
A fifth layer made of Tie resin and having a thickness of 15 μm;
A sixth layer made of EVOH and having a thickness of 15 μm;
A seventh layer made of Tie resin and having a thickness of 15 μm;
An eighth layer made of HDPE1 and having a thickness of 30 μm;
A ninth layer made of LLDPE and having a thickness of 20 μm. The ninth layer is used as a sealant to increase the sealability while also maintaining the total tube material density in the range of the density of the bottle grade of HDPE (0.95).

Thus, the outer layer 210 was made of four layers of HDPE, and the thickness of the outer layer 210 was 155 μm, the thickness of the inner layer 250 was 50 μm, and the total thickness of the flexible package 100 was 250 μm. The HDPE1 material was a bimodal HDPE material with a density of 0.951 g/cm³ and a melt flow index of 1.1 g/10 min. The HDPE2 material was a high-stiffness grade material with a density of 0.965 g/cm³ and a melt flow index of 0.7 g/10 min. The LLDPE was a blend of LDPE, LLDPE, and MDPE, which provided a good sealibility with an average density of 0.93 g/cm³ and a melt flow of <1 g/10 min. The produced film had a basic weight of 240 g/sqm, a coefficient of friction of 0.38/0.37 (static/kinetic), and a free-falling dart impact strength of 400 g. The film had no curling in the transverse direction.

### Example 6: Sleeve Portion 120

This is an improved version of the sleeve portion 120 in Example 5 with improved compatibility between HDPE and EVOH by using a compatibilizer (e.g., Dow's Retain) in the layers close to the EVOH layer. It was a 9-layer blown film sleeve portion 120 with two HDPE materials having different grades plus a thin layer of LLDPE as a sealant layer. The two HDPE materials had different densities and were used to adjust the stress within different layers to obtain a flat film out of the unsymmetrical layer structure. The sleeve portion 120 had the following structure (e.g., from outer to inner):
A first layer made of HDPE1 and having a thickness of 35 μm;
A second layer made of HDPE2 with a white pigment and having a thickness of 40 μm;
A third layer made of HDPE2 with a white pigment and having a thickness of 35 μm;
A fourth layer made of HDPE2 with 10 wt % compatibilizer and having a thickness of 45 μm;
A fifth layer made of Tie resin with 10 wt % compatibilizer and having a thickness of 15 μm;
A sixth layer made of EVOH and having a thickness of 15 μm;
A seventh layer made of Tie resin with 10 wt % compatibilizer and having a thickness of 10 μm;
An eighth layer made of HDPE1 and having a thickness of 30 μm;
A ninth layer made of LLDPE and having a thickness of 20 μm. The overall/average density of the polyethylene in the sleeve portion 120 may be tuned to be in the bottle HDPE density recycling range, which is about 0.95 g/cm³. Thus the a majority of the sleeve portion 120 may be made using HDPE with a density greater than about 0.95 g/cm³, which may allow the use of a small amount of LDPE or LLDPE as a sealant layer.

Thus, the outer layer 210 was made of four layers of HDPE, the thickness of the outer layer 210 was 155 μm, the thickness of the inner layer 250 was 50 μm, and the total thickness of the flexible package 100 was 250 μm. The HDPE1 material was a bimodal HDPE with a density of 0.951 g/cm³ and a melt flow index of 1.1 g/10 min. The HDPE2 material was a high-stiffness grade with a density of 0.965 g/cm³ and a melt flow index of 0.7 g/10 min. The LLDPE was a blend of LDPE, LLDPE, and MDPE, which provided a good sealibility with an average density of 0.93 g/cm³ and a melt flow of <1 g/10 min. The compatibilizer was a functional polymer that promoted compatibility between HDPE and EVOH, such as Dow's Retain 3000. It had a density of 0.87 g/cm³. The produced film had a basic weight of 251 g/sqm, a coefficient of friction of 0.48/0.46 (static/kinetic), and a free-falling dart impact strength of 589 g. The film was flat with no curling in both the machine direction and the transverse direction.

### Example 7: Shoulder Portion 130

The shoulder portion is injection molded from an HDPE material with a density of 0.953 g/cm³ and a melt flow index of 0.95 g/10 min. The processing temperatures are set 20-40° C. higher than those for regular injection molding-grade HDPEs.

The sleeve portion and shoulder portion disclosed herein can be run smoothly on a tube-making machine (e.g., Aisa SAESA®2000s) to make the tubes at the full speed. The tubes disclosed herein meet the critical guidance for HDPE recycling from the association of plastic recyclers (APR).

Secondary Package

In at least one embodiment, the length and/or the width of the flexible package 100 may be smaller than the requirements for the HDPE bottle recycling stream, which would prevent the flexible package 100 from being introduced into the HDPE bottle recycling stream. In this embodiment, one of more of the flexible package(s) 100 may be placed into a larger secondary package (e.g., after the consumer product 102 is dispensed from the one of more of the flexible package(s) 100). The secondary package may have a size and a shape that is within the acceptable range for the HDPE bottle recycling stream, such as a cuboidal- or cylinder-shaped container that is approximately the size of a two liter beverage bottle. Thus, the secondary package with the one or more flexible package(s) 100 positioned therein can be recycled through the conventional HDPE bottle recycling stream. The one or more of the flexible package(s) 100 may also be transported, shelved, and/or sold in the secondary package prior to having the consumer product 102 dispensed therefrom and prior to recycling.

The secondary package may be made from extrusion grade HDPE with a melt flow index from about 0.3 g/10 min to about 3.0 g/10 min. A wall-thickness of the secondary package may be from about 0.05 mm to about 0.20 mm. The secondary package may be made via an extrusion blow molding process with a cover. In this embodiment, any decorations may be placed thereon as an adhesive label. In another embodiment, the secondary package may be made via a thermoforming process. In this embodiment, any decorations may be placed thereon via direct surface printing. In yet another embodiment, the secondary package may be made via an HDPE sheet-folding carton. In this embodiment, any decorations may be placed therein via a pressure-sensitive label or in-mold labelling.

1. A recyclable package, comprising:
an outer layer consisting essentially of a first high-density polyethylene (HDPE);
an inner layer comprising a second HDPE;
a barrier layer positioned between the outer layer and the inner layer;
a first bonding layer positioned between the outer layer and the barrier layer; and
a second bonding layer positioned between the inner layer and the barrier layer.

2. The recyclable package of claim 1, wherein the barrier layer comprises aluminum or plastic.

3. The recyclable package of claim 1, wherein the first bonding layer, the second bonding layer, or both comprise an adhesive material or an extruded melted tie resin.

4. The recyclable package of claim 1, wherein the outer layer consists of the first HDPE, wherein the inner layer consists of the second HDPE, and wherein the first HDPE and the second HDPE are the same.

5. The recyclable package of claim 1, wherein the outer layer consists essentially of two or more different first HDPEs.

6. The recyclable package of claim 5, wherein the two or more different first HDPEs comprise a first outer HDPE having a first density and a first melt flow index and a second outer HDPE having a second density and a second melt flow index, wherein the first density is less than the second density, and wherein the first melt flow index is greater than the second melt flow index.

7. The recyclable package of claim 1, further comprising a sealant layer positioned on an opposing side of the inner layer from the second bonding layer, wherein the sealant layer comprises a linear low-density polyethylene (LLDPE) having a density from about 0.90 g/cm³ to about 0.95 g/cm³ and a melt flow index less than about 1 g/10 min.

8. The recyclable package of claim 1, wherein the outer layer comprises a compatibilizer in an amount from about 5 wt % to about 20 wt %, and wherein the compatibilizer has a density from about 0.85 g/cm³ to about 0.90 g/cm³.

9. The recyclable package of claim 8, wherein the first bonding layer and the second bonding layer also comprise the compatibilizer in an amount from about 5 wt % to about 20 wt %.

10. The recyclable package of claim 1, wherein the package meets requirements for entering a HDPE recycling stream.

11. A recyclable package, comprising:
an outer layer comprising a high-density polyethylene (HDPE),
an inner layer comprising the HDPE, wherein the outer layer and the inner layer do not include a low-density polyethylene (LDPE), a linear low-density polyethylene (LLDPE), a medium-density polyethylene (MDPE), or a polypropylene (PP);
a barrier layer positioned between the outer layer and the inner layer;
a first bonding layer positioned between the outer layer and the barrier layer; and
a second bonding layer positioned between the inner layer and the barrier layer.

12. The recyclable package of claim 11, wherein:
the outer layer has a thickness from about 180 μm to about 210 μm,
the inner layer has a thickness from about 30 μm to about 50 μm,
the barrier layer has a thickness from about 10 μm to about 20 μm,
the first bonding layer has a thickness from about 3 μm to about 10 μm,
the second bonding layer has a thickness from about 3 μm to about 10 μm,
the HDPE has a density that is greater than about 0.95 g/cm³, and
the HDPE has a melt flow index that is less than 1 g/10 min.

13. The recyclable package of claim 11, wherein:
the outer layer comprises a plurality of layers having an aggregate thickness from about 150 μm to about 170 μm,
the inner layer has a thickness from about 40 μm to about 60 μm,
the barrier layer has a thickness from about 10 μm to about 20 μm,
the first bonding layer has a thickness from about 10 μm to about 20 μm,
the second bonding layer has a thickness from about 10 μm to about 20 μm,
the HDPE has a density from about 0.90 g/cm³ to about 1.00 g/cm³,
the HDPE has a melt flow index from about 3 g/10 min to about 5 g/10 min,
the package has a basic weight from about 270 g/sqm to about 310 g/sqm,
the package has a static coefficient of friction from about 0.36 to about 0.46,
the package has a kinetic coefficient of friction from about 0.36 to about 0.46, and
the package has a free-falling dart impact strength from about 430 g to about 460 g.

14. The recyclable package of claim 11, wherein:
the outer layer comprises a plurality of layers having an aggregate thickness from about 160 μm to about 180 μm,
the inner layer has a thickness from about 30 μm to about 40 μm,
the barrier layer has a thickness from about 10 μm to about 20 μm,
the first bonding layer has a thickness from about 10 μm to about 20 μm,
the second bonding layer has a thickness from about 10 μm to about 20 μm,
the HDPE has a density from about 0.90 g/cm³ to about 1.00 g/cm³,
the HDPE has a melt flow index from about 0.8 g/10 min to about 1.4 g/10 min,
the package has a basic weight from about 225 g/sqm to about 265 g/sqm,
the package has a static coefficient of friction from about 0.20 to about 0.30,
the package has a kinetic coefficient of friction from about 0.20 to about 0.30, and
the package has a free-falling dart impact strength from about 450 g to about 480 g.

15. The recyclable package of claim 11, wherein:
the outer layer comprises a plurality of layers having an aggregate thickness from about 120 μm to about 140 μm,
the inner layer has a thickness from about 40 μm to about 50 μm,
the barrier layer has a thickness from about 10 μm to about 20 μm,
the first bonding layer has a thickness from about 10 μm to about 20 μm,
the second bonding layer has a thickness from about 10 μm to about 20 μm,
the HDPE has a density from about 0.90 g/cm³ to about 1.00 g/cm³,
the HDPE has a melt flow index from about 0.8 g/10 min to about 1.4 g/10 min,
the package has a basic weight from about 205 g/sqm to about 245 g/sqm,
the package has a static coefficient of friction from about 0.30 to about 0.40,
the package has a kinetic coefficient of friction from about 0.30 to about 0.40, and
the package has a free-falling dart impact strength from about 390 g to about 420 g.

16. The recyclable package of claim 11, wherein:
the outer layer comprises a plurality of layers having an aggregate thickness from about 145 μm to about 165 μm,
the inner layer has a thickness from about 45 μm to about 55 μm,
the barrier layer has a thickness from about 10 μm to about 20 μm,
the first bonding layer has a thickness from about 10 μm to about 20 μm,
the second bonding layer has a thickness from about 10 μm to about 20 μm,
the HDPE has a density from about 0.90 g/cm³ to about 1.00 g/cm³,
the HDPE has a melt flow index from about 0.5 g/10 min to about 1.0 g/10 min,
the package has a basic weight from about 220 g/sqm to about 260 g/sqm,
the package has a static coefficient of friction from about 0.35 to about 0.40,
the package has a kinetic coefficient of friction from about 0.35 to about 0.40, and
the package has a free-falling dart impact strength from about 385 g to about 415 g.

17. The recyclable package of claim 11,
the outer layer comprises a plurality of layers having an aggregate thickness from about 145 μm to about 165 μm,
the inner layer has a thickness from about 45 μm to about 55 μm,
the barrier layer has a thickness from about 10 μm to about 20 μm,
the first bonding layer has a thickness from about 10 μm to about 20 μm,
the second bonding layer has a thickness from about 10 μm to about 20 μm,
the HDPE has a density from about 0.90 g/cm³ to about 1.00 g/cm³,
the HDPE has a melt flow index from about 0.8 g/10 min to about 1.4 g/10 min,
the package has a basic weight from about 230 g/sqm to about 270 g/sqm,
the package has a static coefficient of friction from about 0.45 to about 0.50,
the package has a kinetic coefficient of friction from about 0.45 to about 0.50, and
the package has a free-falling dart impact strength from about 570 g to about 610 g.

18. The recyclable package of claim 11, wherein the barrier layer comprises aluminum or plastic, wherein the first bonding layer, the second bonding layer, or both comprise an adhesive material or an extruded melted tie resin.

19. The recyclable package of claim 18, further comprising a sealant layer positioned on an opposing side of the inner layer from the second bonding layer, wherein the sealant layer comprises the LLDPE having a density from about 0.90 g/cm³ to about 0.95 g/cm³ and a melt flow index less than about 1 g/10 min, wherein the outer layer comprises a compatibilizer in an amount from about 5 wt % to about 20 wt %, wherein the compatibilizer has a density from about 0.85 g/cm³ to about 0.90 g/cm³, and wherein the package meets requirements for entering a HDPE recycling stream.

20. A recyclable package, consisting of:
an outer layer consisting essentially of a first high-density polyethylene (HDPE);
an inner layer consisting essentially of a second HDPE;
a barrier layer positioned between the outer layer and the inner layer;
a first bonding layer positioned between the outer layer and the barrier layer; and
a second bonding layer positioned between the inner layer and the barrier layer.
